(19) United States
(12) Patent Application Publication
(10) Pub. No.: US 2008/0030938 A1
(43) Pub. Date: Feb. 7, 2008

(54) Display Apparatus Having Space For Controllably Receiving Excess Adhesive And Method Of Fabricating The Same

(76) Inventors: Sang-Il KIM, Yongin-si (KR); Wang-Su Hong, Suwon-si (KR); Jae-Hoon Kim, Yongin-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/832,815

(22) Filed: Aug. 2, 2007

(30) Foreign Application Priority Data
Aug. 2, 2006 (KR) 10-2006-0073069

(51) Int. Cl. G02F 1/00; B32B 7/00

(52) U.S. Cl. 361/681; 156/99

(57) ABSTRACT

In a display apparatus, a spacer maintaining a cell gap between a first substrate and a second substrate is integrally formed to extend from the first substrate, and an adhesive is formed on an upper face of the spacer. The upper face of the spacer is attached to the second substrate by means of the adhesive. An excess adhesive receiving space is defined in and/or above the upper face of the spacer to receive excess amounts of the adhesive that are extruded from between the spacer and the second substrate when the first and second substrates are press joined to each other.

### CROSS-REFERENCE TO RELATED APPLICATION

This application relies for priority upon Korean Patent Application No. 2006-73069 filed on Aug. 2, 2006, the disclosure of which is herein incorporated by reference.

### BACKGROUND

1. Field of the Invention

The present disclosure of invention relates to a display apparatus and a method of fabricating the display apparatus. More particularly, the present disclosure relates to a display apparatus that is structured to deal with an adhesive spill over problem that may occur during assembly and to corresponding methods of fabricating the display apparatus.

2. Description of Related Art

In general, flat-panel type of display apparatuses that display images, such as liquid crystal displays, plasma displays, organic electroluminescent displays, etc., include a multi-substrate sandwich like arrangement. The sandwich like arrangement includes an upper substrate having light-passing materials (e.g., glass, plastic, etc.), a lower substrate in facing relation with the upper substrate and also having light-passing materials (e.g., glass, plastic, etc.), and a separation space between the upper and lower substrates. When the upper and lower substrates are assembled to each other so as to provide a space therebetween, typically spacers are formed in the space between the upper and lower substrates so as to uniformly maintain a distance between the upper and lower substrates. That is, the spacers are typically formed on one of the upper and lower substrates and the spacers makes contact with the other substrate during the joining of the upper and lower substrates, thereby maintaining uniformly the distance between the upper and lower substrates. The spacers are typically positioned at areas of the respective substrates that are other than areas defined as pixel areas. It is desirable to keep the pixel areas free of opaque materials so that passage of light through the pixel areas is not unduly hampered.

In the case where the spacers are formed on the upper substrate, during assembly, the spacers are typically fastened to the lower substrate by using an adhesive. Typically, the adhesive is formed on flat faces of the spacers, which then make contact with the lower substrate during assembly.

However, when the spacers are pressed into attachment with the lower substrate while using the adhesive, an excess amount of the adhesive is typically extruded out laterally from between the spacers and the lower substrate and the adhesive is uncontrollably overflowed outwardly of the spacers and towards areas reserved for use as pixel areas due to a pressure applied to the upper or the lower substrate. As a result of this uncontrolled extrusion of excess adhesive, the display quality of the display apparatus may be deteriorated if the extruded adhesive spills out into undesired areas (e.g., into the pixel areas).

### SUMMARY

According to one aspect of the present disclosure of invention, a display apparatus is provided to include a first substrate, a second substrate in facing opposition to the first substrate, one or more spacers that are structured to control the spillover effect and an adhesive disposed on said one or more spacers. In one embodiment each spacer has an adhesive receiving portion into which extruded adhesive may be received in a controlled manner so as to thereby prevent uncontrolled overflow of the adhesive into undesired regions outside of the spacer.

According to another aspect of the present disclosure, a display apparatus includes a first substrate, a second substrate in facing opposition to the first substrate, a plurality of spacer slabs and depositions of spaced apart adhesive material disposed periodically on the slabs with empty spaces between so that excess adhesive will generally flow into the empty spaces between the periodic depositions of the adhesive material during fabrication.

According to still another aspect of the present disclosure, a method of fabricating a display apparatus is provided as follows. An adhesive is coated on an object, and a spacer is formed on a first substrate. The spacer makes contact with the object to transfer the adhesive to an upper surface of the spacer, and a second substrate is disposed on the adhesive such that the first substrate faces the second substrate. The adhesive is cured to assemble the first and second substrates.

In one embodiment, the spacer is extended in a first direction, and the adhesive is formed at plural positions of the spacer, which are spaced apart from each other, along the extension direction of the spacer. In order to coat the adhesive on the object, a plurality of barrier ribs extended in a second direction, for example, substantially perpendicular to the first direction is formed and arranged along the first direction such that the barrier ribs are spaced apart from each other. Then, the adhesive is coated on upper surfaces of the barrier ribs. The spacer makes contact with the upper surfaces of the barrier ribs.

According to the above, the spacer may be stably attached to the first and second substrates by using the adhesive, and the spacer is provided with a receiving portion in which the adhesive is received, thereby preventing overflow of the adhesive. Other means by which excess adhesive may be received into adhesive receiving spaces will be detailed below.

### BRIEF DESCRIPTION OF THE DRAWINGS

The above and other aspects of the present disclosure will become more readily apparent by reference to the following detailed description when considered in conjunction with the accompanying drawings wherein:

FIGS. 1A to 1F are perspective views illustrating a method of fabricating a display apparatus according to an exemplary first embodiment;

FIGS. 2A to 2E are perspective views illustrating a method of fabricating a display apparatus according to a second exemplary embodiment;

FIG. 3 is a plan view showing an exemplary embodiment of a liquid crystal display according to the present disclosure;

FIG. 4 is a cross-sectional view taken along a line I-I′ of FIG. 3;

FIG. 5A is a plan view showing a spacer of FIG. 3;

FIG. 5B is a cross-sectional view taken along a line II-II′ of FIG. 5A;

FIG. 6A is a plan view showing a spacer of FIG. 3 according to another exemplary embodiment;

FIG. 6B is a cross-sectional view taken along a line III-III′ of FIG. 6A;

FIG. 7A is a plan view showing a spacer of FIG. 3 according to another exemplary embodiment;

FIG. 7B is a cross-sectional view taken along a line IV-IV′ of FIG. 7A;

FIG. 8A is a plan view showing a spacer of FIG. 3 according to another exemplary embodiment;

FIG. 8B is a cross-sectional view taken along a line V-V′ of FIG. 8A; and

FIG. 9 is a table representing an adhesive strength between the first and second substrates when assembled in accordance with a first structure of the spacers.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Where practical, like reference numbers are used to refer to similar elements throughout the drawings although specifics may be different. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” do not exclude embodiments that comprise plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

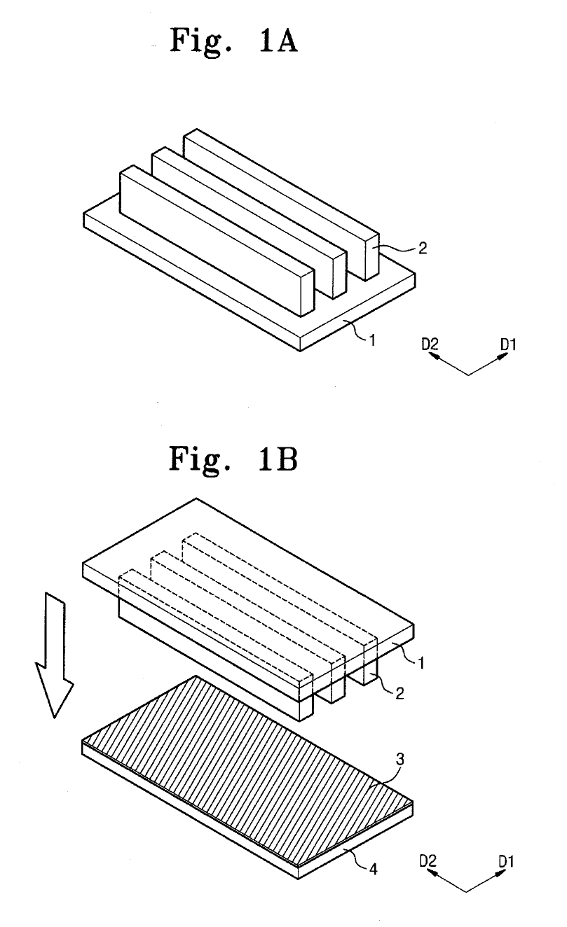

Referring to FIG. 1A, barrier ribs (adhesive carriers) 2 are formed on a first planar object 1. The barrier ribs 2 are disposed one after the other along a first direction D1 such that the barrier ribs 2 are spaced apart from each other, and the barrier ribs 2 are formed to extend longitudinally in a second direction D2 substantially perpendicular to the first direction D1.

The barrier ribs 2 may be formed through various processes. For instance, the barrier ribs 2 may be formed through a photolithography process. Particularly, in one embodiment a material for the barrier ribs 2 is coated on the first object 1, and a photoresist layer pattern (not shown) corresponding to positions where the barrier ribs 2 are formed is formed on the material. When the material is etched using the photoresist layer pattern as an etch mask, the barrier ribs 2 are formed as shown in FIG. 1A.

Alternatively, the barrier ribs 2 may be formed through a stamping process. Particularly, a material for the barrier ribs 2 is coated on the first object 1, and a mold having a shape that is geared with the barrier ribs 2 is prepared. Then, when the mold is pressed onto the material, the barrier ribs 2 are formed in accordance with the mold shape.

Referring to FIGS. 1B and 1D, an adhesive 3 is coated on the barrier ribs 2 (on the adhesive carriers 2). The adhesive 3 is formed only on upper faces of the barrier ribs 2. In order to form the adhesive only on the upper faces of the barrier ribs 2, various methods may be employed.

For example, as shown in FIG. 1B, the adhesive 3 is pre-coated over a second object 4. When the first object 1 is pressed onto the second object 4, the upper faces of the barrier ribs 2 will make contact with the adhesive 3, thereby coating the adhesive 3 only on the upper faces of the barrier ribs 2. Then when the first object 1 is separated away from object 4, the upper faces of the barrier ribs 2 will have patterned strips of adhesive temporarily adhered to them. (In FIG. 1D, the patterned strips of adhesive will be partially transferred to spacers 11.)

As another method of forming the adhesive 3, a roll printing method may be applied to form the adhesive 3 on the upper faces of the barrier ribs 2. Particularly, a roller on which an adhesive is coated on a surface thereof rotates on the upper faces of the barrier ribs 2. The roller rotates along the second direction D2, and the adhesive on the surface of the roller is transcribed on the upper faces of the barrier ribs 2 while rotating along the second direction D2.

Referring to FIG. 1C, spacers 11 are formed on a first substrate 10. The first substrate 10 is configured for use in a flat panel display apparatus and may include various materials such as glass, plastic, etc., for realizing the desired type of flat panel display (i.e. an LCD-type display). The spacers 11 are arranged along the second direction D2 such that the spacers 11 are spaced apart from each other, and the spacers 11 are extended in the first direction D1. The spacers 11 may be formed through the photolithography process or the stamping process.

In case of applying the photolithography process in order to form the spacers 11, a photoresist layer is formed on the first substrate 10, and the photoresist layer is patterned by exposing and developing processes, thereby forming the spacers 11.

In case of the stamping process, the stamping process may be identical with that of the stamping process to form the barrier ribs 2 as described above. That is, a material for the spacers 11 is formed on the first substrate 10, and a mold having a shape that is geared with the spacers 11 is prepared. Then, when the mold is pressed onto the material, the spacers 11 are formed in accordance with the mold shape.

Referring to FIG. 1D, the first object 1 on which the barrier ribs 2 are formed is disposed to be in faced opposition with the first substrate 10 as shown and the first object 1 is pressed onto the first substrate 10. When pressing the first object 1 onto the first substrate 10, the first object 1 is disposed such that the longitudinal axes of spacers 11 intersect in non-parallel fashion with the longitudinal axes of barrier ribs 2. Then, as a result of the first object 1 being pressed onto the first substrate 10, the adhesive 3 coated on the upper faces of the barrier ribs 2 will be transcribed onto several spaced apart positions of upper faces of the spacers 11. That is, since the barrier ribs 2 are spaced apart from each other, the adhesive 3 may be transcribed in the several positions of the upper faces of the spacers 11, which are spaced apart from each other by a distance corresponding to a distance between the barrier ribs 2. This stamp-based transcription process is a non-limiting example of how spaced apart depositions of adhesive material may come to be deposited on the upper faces of the spacers 11. Other selectively additive and/or selectively subtractive process may be used to produce the spaced apart depositions of adhesive material 3 a shown in FIG. 1E.

Referring still to FIG. 1E, a second substrate 20 is prepared and disposed on the spacers 11 formed on the first substrate 10. The second substrate 20 makes contact with the spaced-apart adhesive depositions 3 formed on the upper faces of the spacers 11.

Referring to FIG. 1F, in one class of embodiments, the adhesive material 3 includes a heat-cured resin and/or a light-cured resin, and as a consequence either heat or light 30 may be applied to the second substrate 20 to cure the adhesive 3. In case that the adhesive 3 includes the heat-cured resin, the heat is applied to the second substrate 20 to cure the adhesive 3, and in case that the adhesive 3 includes the light-cured resin, the light is applied to the second substrate 20 to cure the adhesive 3.

The display apparatus fabricated by the above-described processes (FIGS. 1A-1F) has structural characteristics as follows.

First, since the spacers 11 are adhered to the second substrate 20 by means of the spaced-apart depositions of adhesive 3 and the adhesive material has room to resiliently outflow into the spaces between the spaced-apart depositions, then even if an unusually strong external force is applied to the display apparatus after assembly thereof, the spacers 11 will not be permanently deviated from predetermined positions because the adhesive material can spring back to its original position after the unusually strong external force is removed from the display apparatus. As a result, the distance between the first and second substrates 10 and 20 may be uniformly maintained without being affected by external circumstances. This characteristic is advantageous in a display apparatus to which a material having flexibility such as a plastic substrate, an electric-paper, etc., is applied.

Second, since the adhesive 3 is formed as spaced-apart depositions at the several positions of the upper faces of the spacers 11, if during assembly the adhesive 3 is slightly extruded from between the spacers 11 and the second substrate 20 due to a strong external force used during assembly of the first and second substrates 10 and 20 with each other, such extruded adhesive 3 will tend to flow at least partially along top faces of the spacers 11 rather than only out along side faces (sidewalls) of the spacers 11. If the extruded adhesive 3 is diffused only out along the sidewalls and flares out into an image transmitting area of the display area, this flaring out can cause deterioration of the image quality.

However, in accordance with the present embodiment, since empty receiving spaces are provided at the several positions of the upper faces of the spacers 11 for extruded adhesive material, such extruded excess adhesive does not all outflow laterally towards the image transmitting areas (pixel areas) of the display device. That is, a region in which the adhesive 3 is not formed exists between the several positions of the upper faces of the spacers 11. Thus, the adhesive 3 may be flowed toward the region in which the adhesive 3 is not formed when the first and second substrates 10 and 20 are assembled with each other. As a result, the excess adhesive 3 can be flowed along the upper faces of the spacers 11 along the first direction D1, thereby preventing the overflow of such adhesive material 3 laterally to interfere with the pixel areas.

In one embodiment, the first substrate 10 may be a color filters supporting substrate on which color filters are formed and the second substrate 20 may be a thin film transistors containing substrate on which a plurality of thin film transistors (TFT's) are formed. Conversely, the first substrate 10 may be the thin film transistor substrate and the second substrate 20 may be the color filter substrate.

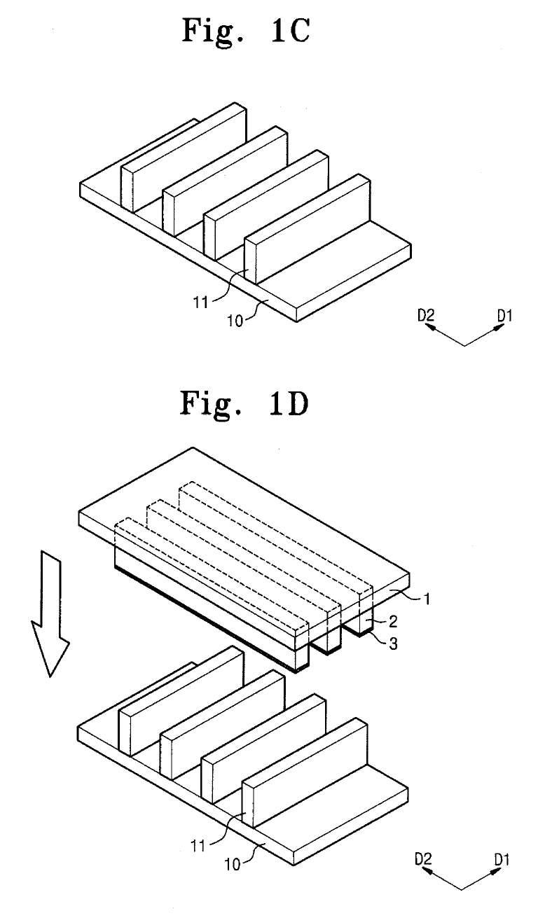

FIGS. 2A to 2E are perspective views illustrating a method of fabricating a display apparatus according to an exemplary second embodiment.

Referring to FIG. 2A, an adhesive layer 510 is coated over an object 500. The object 500 has a plate-like shape such that the adhesive 510 is uniformly coated on the object 500, and is not particularly limited in the material thereof. The adhesive 510 may include a heat-cured resin and/or a light-cured resin. In one embodiment, the adhesive 510 includes an epoxy resin which is coated over the object 500 through various methods, such as a spin-coating method, a roll-printing method and so on.

Referring to FIG. 2B, respective first and second alignment layers 170 and 250 are formed on first and second substrates 100 and 200, respectively. In order to form the first and second alignment layers 170 and 250, a material containing polyimide for example is coated over the first and second substrates 100 and 200 and heated to remove a vapor liquid component thereof.

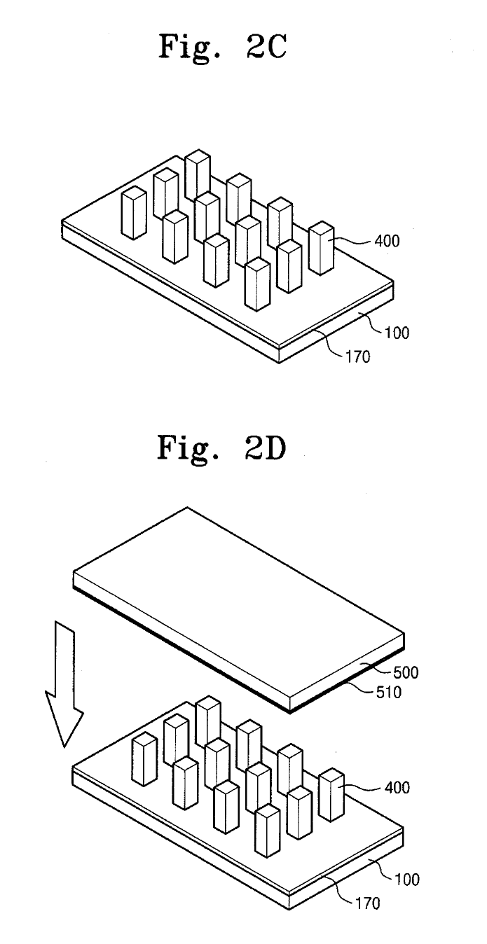

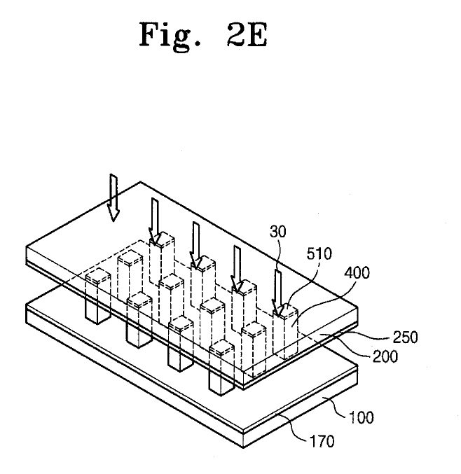

Referring to FIG. 2C, spacer posts 400 are formed on the first alignment layer 170. The spacer posts 400 have a pole shape and are spaced apart from each other. The spacer posts 400 may be formed through a photolithography process or a stamping process. The spacer posts 400 are each provided with a receiving portion 410 (FIGS. 5A-5B) to receive the adhesive 510, and the receiving portion will be described below with reference to FIGS. 5A-5B.

Procedures of forming the first and second alignment layers 170 and 250 and the spacer posts 400 are not limited to the orders described above. That is, the first and second alignments 170 and 250 may be formed after forming the spacer posts 400.

Referring to FIG. 2D, the object 500 is placed to face the first substrate 100 and the object 500 is pressed toward the first substrate 100. Due to the press of the object 500, the adhesive 510 is partially transcribed onto the upper faces of the spacer posts 400 from the object 500 without transcribing the rest of the adhesive onto the first substrate 100.

Then, the first and second alignment layers 170 and 250 formed on the first and second substrates 100 and 200, respectively, are rubbed in a predetermined direction by using a smooth fabric, for thereby aligning a later-supplied liquid crystal in a required direction. The rubbing process may be omitted depending on a driving method used by the liquid crystal display. After rubbing the first and second alignment layers 170 and 250, a sealant pattern (not shown) that combines the first and second substrates 100 and 200 is formed along an end portion of the first substrate 100 or the second substrate 200.

Referring to FIG. 2E, the second substrate 200 is disposed on the upper faces of the spacer posts 400, and heat or light 30 is applied to the first and second substrates 100 and 200 to thereby cure the spaced-apart depositions of adhesive 510 and the sealant pattern. While the adhesive 510 and the sealant pattern are cured, an external force is applied to press the first and second substrates 100 and 200 together to thereby assemble the first and second substrates 100 and 200 to each other. When the sealant pattern is cured, a space sealed by the sealant pattern is provided between the first and second substrates 100 and 200, and the liquid crystal is injected into the sealed space.

The liquid crystal display fabricated by the above-described processes may have structural characteristics as follows.

First, since the spacers 400 are adhered to the second substrate 200 by means of the spaced-apart adhesive depositions 510, the liquid crystal display may prevent the spacers 400 from being deviated from predetermined positions even if the strong external force is applied to the liquid crystal display.

Second, the process of forming the spacer posts 400 to which the adhesive 510 is applied does not apply any adverse influence to the process of forming the first and second alignment layers 170 and 250. Thus, various alignment layers may be applied to the liquid crystal display, and also liquid crystal displays driven in various driving modes may be realized in accordance with kind of the alignment layers and the rubbing methods.

Third, since the above-described processes are simple, they are suitable for mass production with low cost.

Further, the spacer posts 400 may have an additional structural characteristic to prevent overflow of the adhesive 510.

Hereinafter, the liquid crystal display manufactured by the above-described method will be described, and then the additional structural characteristic of the spacers will be described in detail with reference to figures.

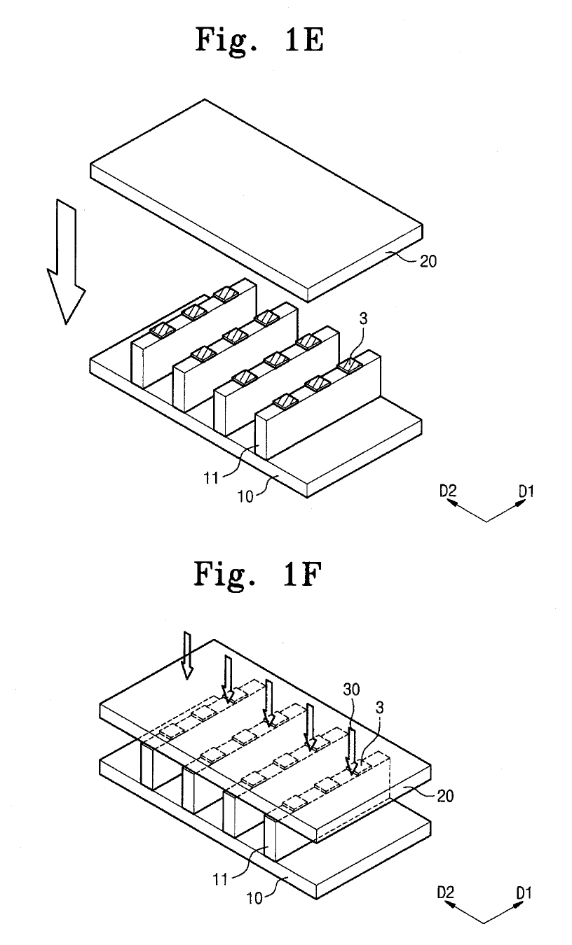

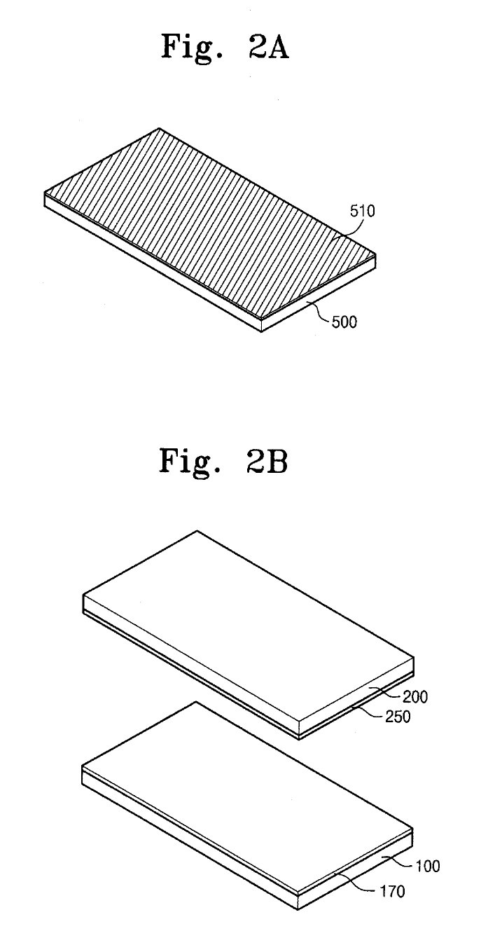

FIG. 3 is a plan view showing an exemplary embodiment of a liquid crystal display according to the present invention, and FIG. 4 is a cross-sectional view taken along a line I-I′ of FIG. 3. In the present embodiment, the liquid crystal display has a plurality of pixel regions, but only one pixel region will be mainly described since all the pixel regions generally have a same configuration.

Referring to FIGS. 3 and 4, the liquid crystal display includes a first substrate 100, a second substrate 200 facing the first substrate 100 and a liquid crystal layer 300 disposed between the first and second substrates 100 and 200.

Gate and data lines 110 and 140 are formed on the first substrate 100, and the gate and data lines 110 and 140 are intersected with each other to define the pixel area PA. The pixel area PA includes a thin film transistor T a pixel electrode 160 and a storage capacitor C.

The thin film transistor T includes a gate electrode 111, a source electrode 141 and a drain electrode 142. The gate electrode 111 is branched from the gate line 11, and a gate insulation layer 120 is formed on the first substrate 110 to cover the gate electrode 111. A semiconductor pattern 130 is formed on the gate insulation layer 120 to cover the gate electrode 111, and the semiconductor pattern 130 includes an active pattern 131 and an ohmic contact 132 partially formed on the active pattern 131. The source and drain electrodes 141 and 142 are spaced apart from each other and formed on the semiconductor pattern 130. The source electrode 141 is branched from the data line 140.

A protective layer 150 is formed on the first substrate 100 to cover the thin film transistor T. The protective layer 150 is provided with a contact hole 150h formed therethrough to partially expose the drain electrode 142. The pixel electrode 160 is formed on the protective layer 150 and electrically connected to the drain electrode 142 through the contact hole 150h. The first alignment layer 170 is formed on the pixel electrode 160.

The storage capacitor C is defined by a first electrode, a second electrode and a dielectric substance disposed between the first and second electrodes. As the first electrode, a storage electrode 112 is formed on the first substrate 100 and spaced apart from the gate electrode 111, the pixel electrode 160 corresponds to the second electrode, and the gate insulation layer 120 and the protective layer 150 correspond to the dielectric substance. The drain electrode 142 may be elongated to an upper portion of the storage capacitor 112 for instead of the pixel electrode 160. In case that the drain electrode 142 serves as the second electrode of the storage capacitor C, only the gate insulation layer 120 serves as the dielectric substance of the storage capacitor C.

A light-blocking layer pattern 210, a color filter 220, an over-coating layer 230, a common electrode 240 and the second alignment layer 250 are sequentially formed on the second substrate 200.

The light-blocking layer pattern 210 is formed at a position corresponding to a boundary between the pixel regions. That is, a portion of the light-blocking layer pattern 210 is partially opened, and the opened portion of the light-blocking layer pattern 210 is filled with the color filter 220. The light-blocking layer pattern 210 blocks the light passing through a region except the pixel region PA. The color filter 220 may include red, green and blue color filters alternately arranged to display color images.

The over-coating layer 230 is formed on the light-blocking layer pattern 210 and the color filter 220. The over-coating layer 230 reduces a step difference between the light-blocking layer pattern 210 and the color filter 220 to planarize a surface of the second substrate 200 and protect the color filter 220. The common electrode 240 is formed on the over-coating layer 230. The common electrode 240 may be formed through a sputtering method using indium tin oxide or indium zinc oxide. The second alignment layer 250 is formed on the common electrode 240.

The spacer posts 400 are formed between the first and second substrates 100 and 200 to maintain a cell gap between the first and second substrates 100 and 200 where the liquid crystal layer 300 is formed. The spacers 400 are formed on the first alignment layer 170 and makes contact with the second alignment layer 250. The adhesive 510 is formed on the upper faces of the spacers 400, and the spacers 400 are adhered to the second substrate 200 by the adhesive 510. On the other hand, the spacers 400 may make contact with the first alignment layer 170 formed on the first substrate 100 after the spacers 400 are formed on the second alignment layer 250 of the second substrate 200.

When the liquid crystal display is operated, the thin film transistor T outputs a present data signal applied to the data line 140 to the drain electrode 142 in response to a present gate signal applied to the gate line 110. Thus, a data voltage corresponding to the present data signal is applied to the pixel electrode 160, and a common voltage is substantially simultaneously applied to the common electrode 240. An electric field is applied across the liquid crystal layer 300 due to a voltage difference between the data voltage and the common voltage.

The data voltage is varied in accordance with the images while the common voltage is maintained uniformly, so that the electric field corresponding to the images is applied to the liquid crystal layer 300. As a result, the arrangement of liquid crystal molecules of the liquid crystal layer 300 and the light transmittance of the liquid crystal molecules are varied, thereby displaying the images corresponding to the arrangement of the liquid crystal molecules.

In operation of the liquid crystal display, since the distance between the first and second substrates 100 and 200 may cause variations of a volume of the liquid crystal layer 300 and an intensity of the electric field, the distance may influence operation of the liquid crystal display.

In accordance with the illustrated embodiment, the spacers 400 are formed on the first substrate 100 and adhered to the second substrate 200 by the adhesive 510, so that the distance between the first and second substrates 100 and 200 may be maintained uniformly by the spacers 400.

When viewed from a plan view, the spacers 400 are formed outside the pixel region PA. That is, the plan head on view of the spacer posts 400 is overlapped with the data line 140 when viewed head on from a side of the first substrate 100 and it is aligned with the light-blocking layer 210 when viewed head on from a side of the second substrate 200. On the other hand, the spacers 400 may be formed at positions corresponding to the gate line 110 or the thin film transistor T, which is covered by the light-blocking layer pattern 210.

The spacers 400 typically include a nontransparent material, thereby causing lowering of an aperture ratio of the pixel region PA if the spacers 400 are inadvertently formed to extend into the pixel region PA. Thus, the spacers 400 are ideally formed at the positions to minimize the lowering of the opening ration of the pixel region PA. The light-blocking layer pattern 210 blocks the light, and the gate line 110, the data line 140 or the electrodes 111, 141 and 142 of the thin film transistor T include a metal material that blocks the light, such as chromium, aluminum, etc., so that it is proper that the spacers 400 are formed to be overlapped with the light-blocking layer pattern 210, the gate and data lines 110 and 140, or the electrodes 111, 141 and 142.

In the illustrated embodiment, in order to position the spacers 400 at the regions through which the light does not pass, the adhesive 510 includes a heat-curing resin rather than a light-cured resin. This is because the adhesive 510 cannot be cured by the light in its light blocked position. However, in alternate embodiments where light can be irradiated onto the liquid crystal display in positions where the adhesive is present, the adhesive 510 may includes a light-cured resin.

However, the light-blocking layer pattern 210 is not limited to be formed on the second substrate 200 and may be formed on the first substrate 100. In this case, although the adhesive 510 includes the light-curing resin, the adhesive 510 may be cured by the light applied from outside the second substrate 200.

If the light-blocking layer pattern 210 is formed on the second substrate 200 and the adhesive 510 includes the light-curing resin, the spacers 400 may be formed in the pixel region PA through which the light passes. In case that the spacers 400 are formed in the pixel region PA, the spacers 400 are formed at an end portion 401 of the pixel region PA such that the liquid crystal molecules are readily aligned. Further, the spacers 400 may be formed on the storage electrode 112 that includes a metal material through which the light does not passes.

Hereinafter, various structures of the spacers 400 that may be used to prevent the lateral overflow of the adhesive 510 into the pixel areas (PA) will be described in detail.

FIG. 5A is a plan view showing the spacer of FIG. 3 according to a first possible exemplary embodiment, and FIG. 5B is a cross-sectional view which may be one taken along a line II-II′ of FIG. 5A for example. In FIGS. 5A and 5B, one spacer of the spacers 400 will be described as an example and the same reference numeral as the spacers is applied thereto.

Referring to FIGS. 5A and 5B, the spacer 400 is provided with a recess 410 formed on the upper face thereof to serve as a receiving space for excess adhesive and thus prevent or reduce the lateral overflow of the adhesive 510 into the pixel areas. When the first and second substrates 100 and 200 are assembled to each other, the adhesive 510 that is not cured is extruded from between the spacer 400 and the second substrate 200 due to the external force applied to the first and second substrates 100 and 200. If the receiving space 410 were not there and all of the extruded adhesive 510 is forced to flow downwardly along the outside sidewall of the spacer 400, the adhesive 510 may flare out laterally into the pixel region PA, thereby causing possible contamination of the liquid crystal and lowering of the display quality.

According to the embodiment of FIG. 5B, at least part of the extruded adhesive 510 will be received in the recess 410, to thereby prevent or reduce the overflow of the adhesive 510 all to the outside of the spacer 400.

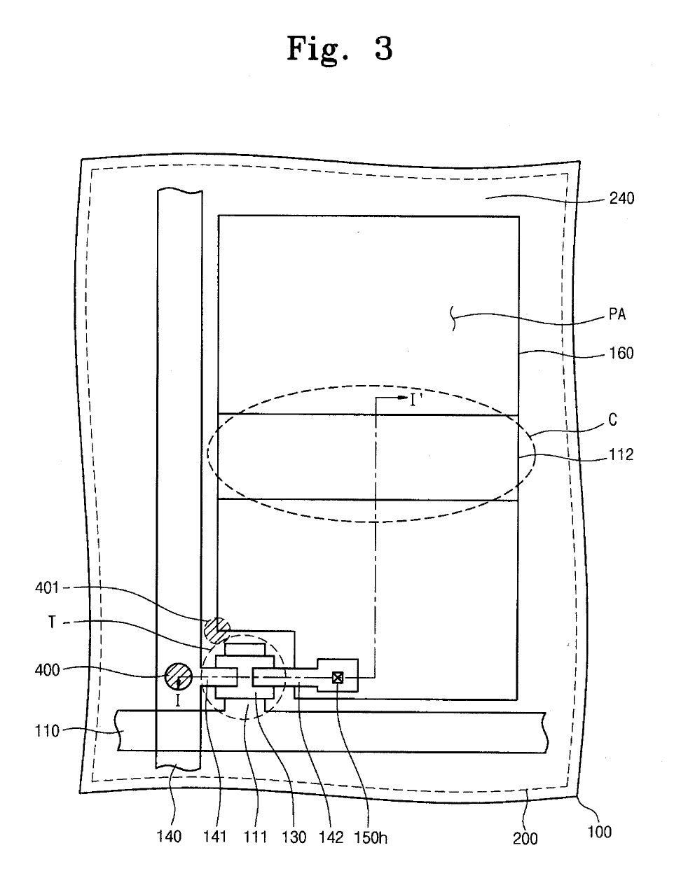

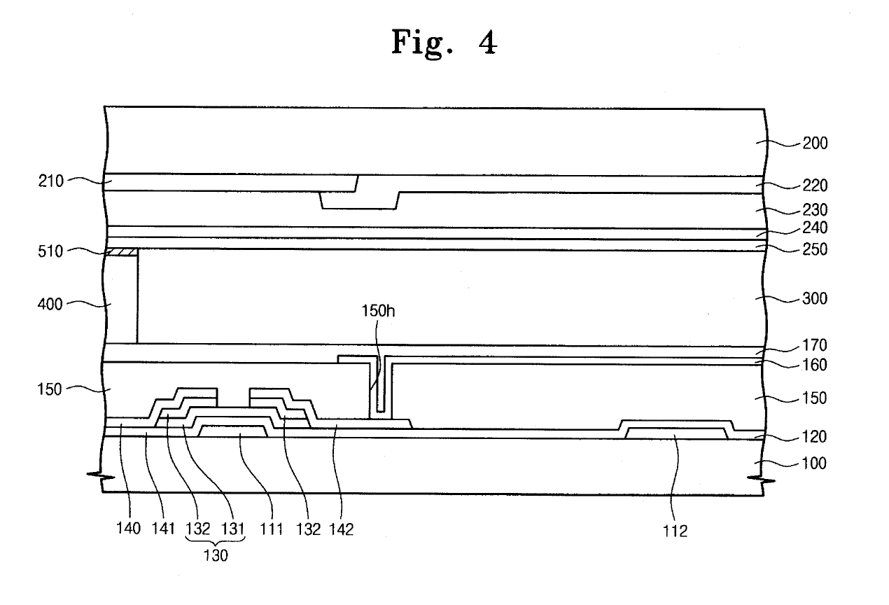

In order to form the recess 410 on the upper face of the spacer 400, in one embodiment the exposure amount of the photolithography process (see FIG. 2C) for the spacer 400 is controlled differently in accordance with regions of the spacer 400. For instance, in case that the spacer 400 is formed using a positive-type photoresist layer, a slit mask or a halftone mask is used to pattern the photoresist layer. Thus, the light advancing to a region in which the spacer 400 is formed is blocked, the light advancing to a region from which the photoresist layer is removed is not blocked, and the light advancing to a region in which the recess 410 is formed is partially blocked such that a portion of the light is provided to the region in which the recess 410 is formed. As will become apparent shortly (from FIG. 6A), in another variation it is possible to not use the slit mask or the halftone mask to pattern the photoresist layer, and additional exposures and developments may be applied to define the adhesive-receiving recess 410 as extending slightly or more deeply down into the interior of the spacer post 400. Also the top of the spacer post need not be planar but may instead have a funnel or V-shape that guides all or a substantial portion of extruded adhesive down into the adhesive-receiving recess.

FIG. 6A is a plan top view showing another embodiment possible for the spacer post of FIG. 3 and FIG. 6B is a cross-sectional view which may be taken along a line III-III′ of FIG. 6A or sectioning through a post with a different top view shape (i.e. not circular).

Referring to FIGS. 6A and 6B, the second spacer post 400 is provided with a vertical opening 420 defined deep into or through the interior of the post, and the opening 420 may have various shapes, the main point being that opening 420 serves as an adhesive receiving space for accommodating excessive adhesive that may be extruded during a pressing together of the upper and lower display substrates.

For instance, the opening 420 may have a circular shape corresponding to the illustrated top view shape of the spacer 400 as seen in FIG. 6A. If the top view shape is instead a square, the top view of the opening 420 may similarly be of corresponding a square shape. That is, in the case where both of the spacer 400 and the opening 420 have a cylinder shape, and thus the second spacer 400 has a tubular shape. When both of the spacer 400 and the opening 420 have a substantially cuboidal shape, the spacer 400 may have the shape of a rectangular shell. Also, the spacer 400 and the opening 420 may have various different shapes.

As described above, the shapes of the spacer 400 and the opening 420 are not limited to specific shapes such as the cylinder shape, the cuboidal shape, etc. The main point is that the extruded excessive adhesive 510 is flowed into the receiving space of the opening 420, thereby preventing the overflow of the adhesive 510 outside the spacer 400. Although not specifically shown, vent holes may be provided (for example in the upper substrate) for vapors that are out-gassed from the curing adhesive material including from that which is guided into the space of the opening 420.

As may be seen by comparing FIGS. 5B and 6B, the receiving volume defined by the deeper opening 420 of FIG. 6B is greater than the volume defined by the recess 410 of FIG. 5B, so that the second spacer 400 provided with the deeper opening 420 is advantageous when a thicker layer of adhesive is used and a lot of excess adhesive may be generated during compression of the upper and lower substrates.

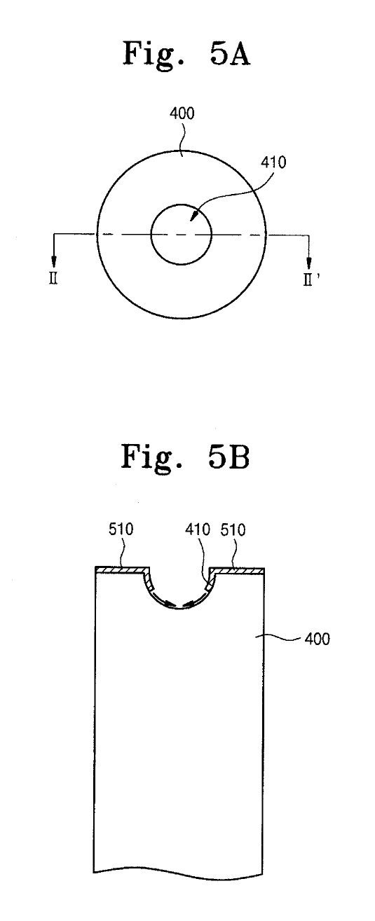

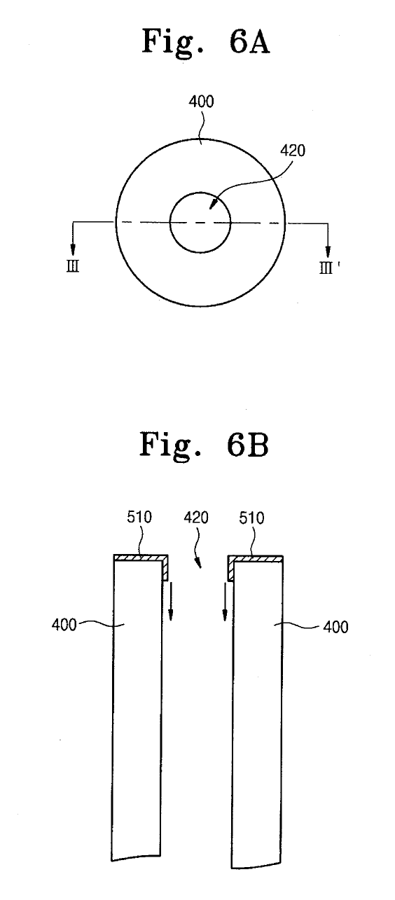

FIG. 7A is a top plan view showing a third version of the spacer post 400 of FIG. 3 and FIG. 7B is a cross-sectional view that may be taken along a line IV-IV′ of FIG. 7A or across the top view of a post with another top view shape.

Referring to FIGS. 7A and 7B, it is seen that opening 430 is not fully bounded at its periphery and that the third spacer 400 is actually formed by closely spacing together a first spacer prism 400a and a second spacer prism 400b that is spaced apart from the first spacer prism 400a. Other shapes for forming an interior opening 430 that is not fully bounded may be used. In the illustrate example, the first and second spacers 400a and 400b have a same shape and are symmetrical with each other. The tight space 430 between the first and second spacers 400a and 400b may function as a capillary guiding space that uses capillary forces to guide extruded portions of the adhesive 510 into being received into the space 430 between the first and second spacers 400a and 400b.

When the first and second spacers 400a and 400b are assembled in close proximity to each other, the excess portion of the adhesive 510 is flowed into the space between the first and second spacers 400a and 400b much as a fluid is guided into flowing into and whetting the interior surface of a capillary tube. Further, since the adhesive 510 has cohesion to the surface material of the spacer posts, the adhesive 510 may be continuously flowed into the receiving space between the first and second spacers 400a and 400b with relatively little or not excess adhesive overflowing outside of the spacer 400 and into the light passing region of the pixel area (PA).

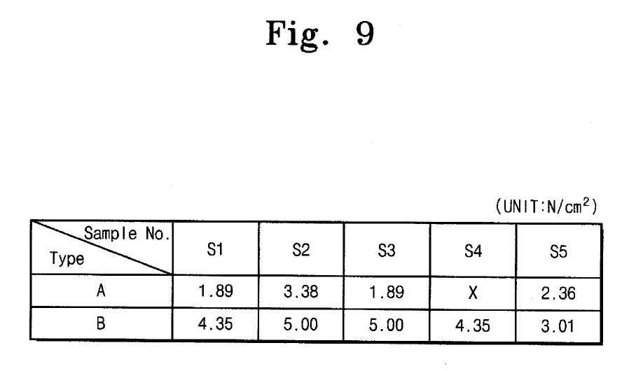

The shapes of the first and second spacers 400a and 400b are not limited to specific shapes, but in one embodiment, sizes of the first and second spacers 400a and 400b and the distance between the first and second spacers 400a and 400b are to be bounded to specific numerical values as shown for example in FIG. 9 such that the adhesive 510 is readily flowed into the space between the first and second spacers 400a and 400b. More generally, each of the first and second spacers 400a and 400b has a width d2 as shown in FIG. 7B that is substantially greater than the separation distance d1 therebetween. If the distance d1 is made too large when compared with the width d2 so as to eliminate guiding forces provided by capillary action or the like, much of the excess adhesive 510 may flow equally to the outside of the first and second spacers 400a and 400b as opposed to flowing mostly into the interior opening 430 defined therebetween. Thus, in one embodiment, the distance d1 is in a range of about 5 micrometers to about 15 micrometers in accordance with a corresponding size of the liquid crystal display and the spacing d2 is substantially smaller.

Further, choice of materials for the spacer 400 and the adhesive 510 can be important factors for reducing or preventing the undesired overflow of the adhesive 510 externally towards the pixel areas (PA). In other words, when the materials of the spacer 400 and the adhesive 510 are chosen to have low interfacial energies with respect to one another (good whettability of the adhesive to the surface material of the receiving opening 430 defined in the spacer 400, the overflow of the adhesive 510 into the PA region may be more certainly reduced or prevented.

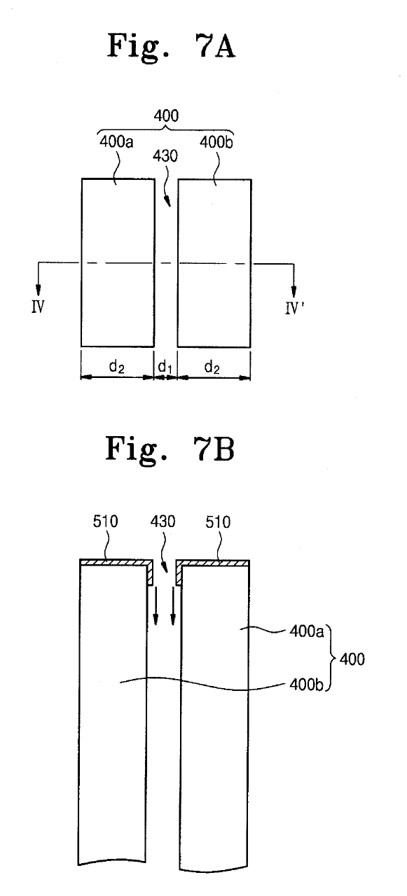

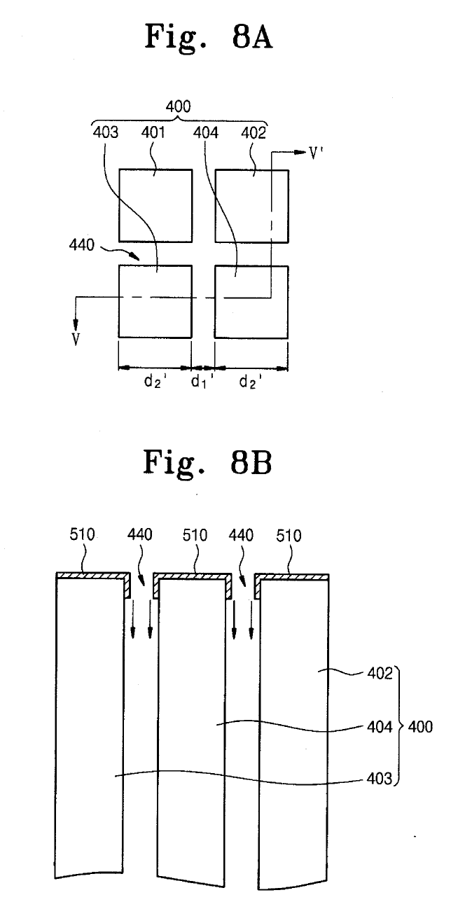

FIG. 8A is a top plan view showing a fourth variation of the spacer 400 of FIG. 3 and FIG. 8B is a cross-sectional view which may be taken along a line V-V′ of FIG. 8A or along a different sectioning line defined across a top view having a different top view shape.

Referring to FIGS. 8A and 8B, the main spacer post 400 includes first, second, third and fourth subsidiary spacers 401, 402, 403 and 404. The first to fourth subsidiary spacers 401, 402, 403 and 404 have a same shape and are placed at positions corresponding to four corners of a square or rectangle, respectively. The first to fourth spacers 401, 402, 403 and 404 are spaced apart from each other as shown in FIG. 8A, and extruded excess adhesive 510 can be received into an adhesive receiving space (i.e., cross shaped width d1′ for each cross piece) as defined between the inwardly facing surfaces of the first to fourth spacers 401, 402, 403 and 404. Among the first to fourth spacers 401, 402, 403 and 404, two spacers, which are adjacent to each other in a direction substantially parallel to a side of the rectangle, are spaced apart from each other by a predetermined distance d1′. The distance d1′ between the adjacent two spacers is smaller than a width d2′ of each subsidiary spacer with respect to the direction crossing the adjacent two spacers. For instance, each of the third and fourth spacers 403 and 404 has the width d2′ that is substantially larger than the distance d1′ therebetween. In order to induce a capillary tube like drawing-in phenomenon for excess adhesive that is to be drawn into the adhesive receiving space between the first to fourth spacers 401, 402, 403 and 404, in one embodiment the distance d2′ between the adjacent two subsidiary spacers is in a range of about 5 micrometers to about 15 micrometers in accordance with a corresponding size of the liquid crystal display.

Although not shown in figures, the space in which the adhesive 510 is received may have various other shapes. For instance, the spacer 400 may be divided into three, four or six spaced-apart subsidiary parts that define an adhesive receiving space therebetween and the subsidiary parts do not need to have a same shape or a symmetrical shape. In case of increasing the number of the parts, adhesion strength between the first and second substrates 100 and 200 may be enhanced as shown in FIG. 9.

FIG. 9 is a table representing adhesive strength (measured in terms of Newtons per cm² at the point of rupture) between the first and second substrates in accordance with the structure of the spacers. In FIG. 9, a type “A” represents that the spacer 400 is divided into two parts (see FIGS. 7A and 7B), and a type “B” represents that a same initially sized spacer 400 is divided into four parts (see FIGS. 8A and 8B). Experiments for each type have been repeatedly carried out about five times as represented by column headings S1-S5 (no S4 measurement for the A row). The adhesive strength between the first and second substrates 100 and 200 has been represented by a minimal external tearing-apart force applied to the first and second substrates 100 and 200 so that the first and second substrates 100 and 200 are completely separated from each other.

Referring to FIG. 9, an average adhesive strength of the A-type samples has been measured at about 1.50 N/cm², and an average adhesive strength of the B-type samples has been measured at about 4.34 N/cm². In the experiments, considering the assembling of the first and second substrates 100 and 200 using only the adhesive 510, the A-type samples and the B-type samples have been represented by adhesives having same relatively superior adhesive strengths. As seen form the results of FIG. 9, the B-type samples wherein the number of the divided parts of the spacer 400 is greater than that of the A-type samples exhibited a superior bonding strength between the upper and lower substrates as compared to the A-type samples.

As described above, the adhesive strength between the first and second substrates 100 and 200 may therefore depend on the number of the divided parts of the spacer 400. Thus, the number of the divided parts of the spacer 400 may be variously adjusted in accordance with the size of the display apparatus and the level of bonding strength desired.

According to the above therefore, each main spacer (i.e., 400) is provided with an adhesive receiving space or recess defined therein for safely receiving at least a portion of excess adhesive that may be extruded during press joined of the upper and lower substrates. In one class of embodiments each main spacer (i.e., 400) is divided into plural, spaced-apart subsidiary parts so as to provide the adhesive receiving space and adhesive-philic surface areas in the interior portion of the main spacer so that an overflow of the adhesive towards the outside of the main spacer post (400) may be reduced or prevented when the first and second substrates are assembled using the adhesive.

Although a number of exemplary embodiments have been described, it is understood that the present disclosure of invention should not be limited to these exemplary embodiments but rather that various changes and modifications in accordance with the disclosure can be made by one of ordinary skilled in the art after having studied the present disclosure.

What is claimed is:

1. A display apparatus comprising:
a first substrate;
a second substrate facing the first substrate;
a spacer formed on the first substrate; and
an adhesive formed on the spacer to adhere the spacer to the second substrate,
wherein the spacer has an adhesive receiving space defined therein into which excess amounts of the adhesive may be received when the first and second substrates are pressed together during assembly.

2. The display apparatus of claim 1, wherein the adhesive receiving space is defined by at least one recess formed on an upper surface of the spacer.

3. The display apparatus of claim 1, wherein the adhesive receiving space is defined by at least one opening that is formed through the spacer such that the first substrate is exposed through the opening.

4. The display apparatus of claim 1, wherein the spacer comprises plural subsidiary spacers spaced apart from each other, and the adhesive receiving space is defined by space between the spaced-apart subsidiary spacers.

5. The display apparatus of claim 4, wherein the spacer comprises two subsidiary spacers, and a distance between the two subsidiary spacers is smaller than a width of each subsidiary spacer with respect to a direction crossing the two subsidiary spacers and the distance therebetween.

6. The display apparatus of claim 4, wherein the spacer comprises four subsidiary spacers that are positioned at four corners of a rectangle, respectively, and a distance between two subsidiary spacers that are adjacent to each other in a direction substantially parallel to a side of the rectangle is smaller than a width of each subsidiary spacer with respect to a direction crossing the adjacent two spacers.

7. The display apparatus of claim 4, wherein a distance between two subsidiary spacers adjacent to each other is in a range of about 5 micrometers to about 15 micrometers with respect to a direction crossing the adjacent two spacers.

8. The display apparatus of claim 1, wherein the first and second substrates each comprises a flexible plastic material.

9. The display apparatus of claim 1, further comprising a liquid crystal layer disposed between the first and second substrates.

10. The display apparatus of claim 9, further comprising a first liquid crystal alignment layer formed between the first substrate and the spacer and a second liquid crystal alignment layer formed on the second substrate.

11. A display apparatus comprising:
a first substrate;
a second substrate facing the first substrate;
a spacer formed on the first substrate and extended in a predetermined direction; and
an adhesive formed on the spacer along the direction to attach the spacer to the second substrate, the adhesive being formed at plural spaced-apart positions of an upper face of the spacer and the adhesive not being disposed in spaces between said plural spaced-apart positions.

12. The display apparatus of claim 11, wherein the first and second substrates each comprises a flexible plastic material.

13. A sandwiched assembly for use in a display device that is to have a plurality of substantially unobstructed light passage areas serving as pixel areas, the assembly comprising:
a first substrate having first light passage areas corresponding to said pixel areas;
a second substrate having second light passage areas corresponding to said pixel areas;
a plurality of spacer posts disposed between the first and second substrates, where the spacer posts are each nominally positioned in an area other than one corresponding to said first and second light passage areas and where each spacer post has a first end structured for joining the spacer post with the first substrate by pressing the spacer post towards the first substrate; and
a plurality of adhesive depositions provided on the first ends of the spacer posts for adhesively joining the corresponding spacer posts with the first substrate;
wherein an excess receiving space is provided for each of said adhesive depositions to receive extruded excess amounts of the adhesive depositions when the corresponding spacer posts are pressed towards the first substrate, each excess receiving space being disposed away from said first and second light passage areas so that the extruded excess amounts of the adhesive received by the respective receiving space kept away from interfering with passage of light through said first and second light passage areas.

14. The sandwiched assembly of claim 13 wherein:
there are plural spaced-apart depositions of adhesive on each first end of each respective spacer post.

15. The sandwiched assembly of claim 13 wherein:
a relatively shallow and interior recess is formed into each first end of each respective spacer post so as to thereby define at least part of the corresponding excess receiving space.

16. The sandwiched assembly of claim 13 wherein:
a relatively deep and bounded interior opening is formed into each first end of each respective spacer post so as to thereby define at least part of the corresponding excess receiving space.

17. The sandwiched assembly of claim 13 wherein:
a not fully bounded opening that has a capillary in-drawing effect in order to draw excess uncured adhesive thereinto is defined into each first end of each respective spacer post so as to thereby define at least part of the corresponding excess receiving space.

18. A method of fabricating a display apparatus, comprising:
coating a transcribable adhesive on a temporary supporting object;
forming a plurality of spaced-apart spacer posts on a first substrate;
contacting the spacer posts with the temporary supporting object so as to thereby selectively transfer the transcribable adhesive from the object to respective upper surfaces of the spacer posts;
joining a second substrate to the adhesive-coated upper surfaces of the spacer posts while the first substrate faces the second substrate; and
curing the adhesive to thereby adhesively join the first and second substrates.

19. The method of claim 18, wherein at least one spacer post has an excess receiving space defined in or above the upper surface thereof to receive an excess portion of the adhesive when the second substrate is joined to the adhesive-coated upper surfaces of the spacer posts.

20. The method of claim 19, wherein the receiving space is at least one recess formed on the upper surface of the spacer.

21. The method of claim 19, wherein the receiving space is at least one opening that is formed through the spacer such that the first substrate is exposed through the opening.

22. The method of claim 19, wherein the spacer comprises plural spacers spaced apart from each other, and the receiving space is defined between the spacers.

23. The method of claim 18, wherein the spacer is extended in a first direction, and the adhesive is formed at plural positions of the spacer, which are spaced apart from each other, along the direction.

24. The method of claim 23, wherein the coating of the adhesive on the object comprises:
forming a plurality of barrier ribs extended in a second direction substantially perpendicular to the first direction and arranged along the first direction such that the barrier ribs are spaced apart from each other; and
coating the adhesive on upper surfaces of the barrier ribs, and
wherein the contacting of the spacer comprises making contact the spacer with the upper surfaces of the barrier ribs.

25. The method of claim 18, further comprising forming a light-blocking layer pattern on the first substrate to allow the light blocking layer to be corresponded to boundaries between pixel areas defined on the first substrate.

26. The method of claim 25, wherein the spacer is overlapped with the light-blocking layer pattern when viewed in a plan view, and the adhesive is cured by a heat treatment.

27. The method of claim 25, wherein the spacer is formed in the pixel areas adjacent to the light-blocking layer pattern, and the adhesive is cured by a heat treatment.

28. The method of claim 18, wherein the first and second substrates comprise a flexible plastic material.

29. The method of claim 18, further comprising forming a liquid crystal layer between the first and second substrates.

30. The method of claim 29, further comprising:
forming a first liquid crystal alignment layer between the first substrate and the spacer; and
forming a second liquid crystal alignment layer on the second substrate.

31. The method of claim 30, further comprising:
rubbing the first alignment layer after the spacer is formed; and
rubbing the second alignment layer after the second alignment layer is formed.

32. The method of claim 18, wherein the spacer posts are formed through a photolithography process.

33. The method of claim 18, wherein the spacer posts are formed through a stamping process.
